(19) United States
(12) Patent Application Publication
(10) Pub. No.: US 2002/0016821 A1
(43) Pub. Date: Feb. 7, 2002

(54) Medical data exchange method

(76) Inventors: Byeong-Keon Son, Mobile, AL (US); Eric Lazo, Mobile, AL (US)

Correspondence Address: Gregory M. Friedlander & Associates, P.C., 11 South Florida Street, Mobile, AL, 36606-1934, US

(21) Appl. No.: 09/922,342

(22) Filed: Aug. 3, 2001

Related U.S. Application Data
(60) Provisional application No. 60/223,249, filed on Aug. 4, 2000.

(51) Int. Cl. G06F 15/16

(52) U.S. Cl. 709/204

(57) ABSTRACT

The specification discloses the process of imaging an object, typically by digitally obtaining medical radiological studies and storing these centrally with access through prioritizing the data for data streaming and converting the digital data as it is to be steamed to an analog format. The images are associated with markers which allow the image to be enhanced and associated with documents analyzing the images, including billing information. Exchanging and interpreting data is provided by having shared screen access to particular data identified by thumbnail or other marker.

### PRIORITY

This patent application claims priority based on provisional application Ser. No. 60/223249 Filed Aug. 4, 2001.

### BACKGROUND OF INVENTION

1. Field of Invention

The present invention is directed to a method of handling and imaging data. More particularly, the invention relates to imaging and handling data in the industrial and medical field and manipulating the image in order to have an enhanced product. More particularly, the present invention is directed toward digitization of data and an enhanced method for handling images, including billing information and an enhanced method for exchanging and interpreting data.

2. Prior Art

The prior art comprises techniques for data storage and digital information preparation as well as internet communications.

### GENERAL DISCUSSION OF THE INVENTION

The present invention is directed to a method of imaging data in the medical field and manipulating the image in order to have an enhanced product. More particularly, the present invention is directed toward digitization of data and an enhanced method for handling images, including billing information and an enhanced method for exchanging and interpreting data.

Elements of the enhancement include marking with color and shading according to a standardized table utilizing a central database for image manipulation with standard marking criteria, colorization from a remote site, storing the data for a remote examination or analysis of the image, and allowing all of these activities to be accomplished from a remote access with the use of hard copies limited or eliminated according to user discretion. Instead of hard copies, the invention utilizes digital images displayed electronically.

Other elements include a method of storing the data and retrieving the data in various medical or industrial environments which include electronic graphical displays of data from a remote site on a screen as well as the retrieval through portable digital storage units with subsequent display through an electronic image. In order to make this possible, a novel method of manipulation of digitized images is disclosed.

The technology specifically allows for data streaming to displays without storage except at the central location so patient records are maintained.

The most specific use the technology disclosed herein lies in its specific application to medical technology. However, other areas where this technology may be appropriately applied would include cat scans, magnetic resonance imaging, gamma ray imaging, and photographic imaging.

In addition a combination of photograph and imaged technologies or different imaged technologies from identical angles may be utilized in order to produce an enhanced product whereby the images may be viewed as adjacent images at the same time or overlaid. Additionally disclosed herein is a method for viewing enhanced images where the same angle is obtained utilizing computer enhancement and rotation of images from different angles to provide a common angle for two different images.

The preferred embodiment is the aspect of using a photographic and radiographic images. It can be seen that the overlay of two radiographic images in order to give a better overall view for various purposes is envisioned.

The use of digitization allows for the use of smart technology in order to accomplish these overlays and in order to eliminate unnecessary elements and highlight necessary elements of the overlay.

Because the date is digitalized, outline drawings based, for example, on intensity, can reduce the drawing to its outlines.

Because windowing technology is utilized in this fashion additional windows may include additional data. One of the more effective uses separate windows for video conferencing, CPU image, and CPU data display and CPU access could also include a window opening into a web site.

This would allow the users to call up from the web site or from a forum in a non-web site format comparable images, articles or even advice for purposes of analysis and comparison.

### EXAMPLES

One example of a use of the process would be to have the image of a body location and a second image of an operable area within the body which may be superimposed upon one another in order to determine the best position for entering body. They may then be separated so that the images may be analyzed separately. Both separate images and their combination may be displayed utilizing the concepts and the technology embodied within this concept.

A patient who is in a motor vehicle accident receives at least one imaging study, typically an x-ray and then goes to an emergency room doctor for an examination.

The digital image in this example is posted on the system which checks to see what radiology group is in attendance. This allows a PPO or HMO to select a group in a remote area which can participate with an immediate service provider in another location. The emergency room doctor might be replaced by a nurse or a medical technician.

The display is within the office of the physician. It may be projected onto a screen or in the case of an operating room an image may be displayed directly on the patient or on the operating table, to an eyeglass type viewing system or other heads up display.

At the same time a camera may be trained on the patient. All of these frames or selected frames from this group may be displayed together.

If the symptoms of the patient dictate an electronic monitoring device such as a blood pressure monitor, an oxygen saturation level monitor, etcetera may be added to the patient. The display with or without modification may then be posted on one of the multiple screens sections. A second or third attending physician may be brought in, such as an internal medicine doctor, in order to analyze these readings either in real time as the data is stored on the Internet.

Several different radiologists may be contacted so that one who is free in order to make an immediate assessment of the radiology report. A doctor immediately available to access the other medical data being uploaded to the system may give feedback by camera or by instant mail message or email message to the emergency room physician in this example.

Also where an expert on site is requires in the given example a radiologist doctor the system may allow for scheduling through the hospital. The consult could operate within the remote system, instead of being on location. In this way, technicians who know how to operate equipment may operate in place of physicians or more highly trained technicians in order to make initial emergency or non-emergency determinations.

Where multiple regional services are to be provided the hospital administrator may also come onto one of the screens in order to do scheduling with the scheduling nurse of a particular associated physician.

All of this can be done during the emergency room treatment and the display may be transferred from location to location so that when the patient is necessary part he may be brought into the loop and when the patient is not a necessary part, the physician may go to another screen which may switch from one patient display to another patient display in response to incoming communications from a remote location in the hospital or from a remote specialist who is reviewing the data or by direction of the treating emergency room physician. The list of participants is maintained for later review and billing.

At the end of the treatment, after the selection of storage options, the records are sent to a centralized storage unit and maintained together according to the criteria set out in more detail below for storing the medial data. This way at any later point in time all of the data related to this patient may be accessed.

At the same time the remote location or the local location of the emergency room hospital will have the patient information docketed for various purposes such as follow up treatment, billing, admission, etcetera. This information may be split and portions duplicated at two levels: locally and at the remote location so that reminders may be utilized in order to maintain the cooperation of the parties.

To give a separate example a physician may be working in an emergency room in a teaching hospital. Ongoing medical data is displayed in certain screens with the actual operating environment on another screen and electronic data on a third screen all of which are display separate locations, one in the operating room and one in a teaching classroom. Also records designated by the physician may be displayed over the patient so that, for example, the location of particular incisions may be determined specificity. The patient may be prepped in order to better illuminate this type projection.

In this way a medical school at a remote location could show live video and even ask questions and obtain feedback related to a particular surgery which might be fairly common in the work environment but unavailable for the classroom either because of its remoteness or because of the unavailability of that procedure at the time when the lesson is scheduled.

It would give students an opportunity to be exposed to the system in order to learn how to properly utilize it.

Where a person is being transported to a hospital and data is being maintained, the data may include electronic data or pictorial data so that the people in the emergency room may begin to prepare for the patient and better communicate. Because the information may be stored, it may be possible for a physician to be brought up to speed on a patient, despite the fact that the emergency data has been previously stored. Since it can be viewed from the Internet, the physician may view it from any location. This will help to prevent the loss of data by temporarily or permanently incorporating data into a database for later retrieval. The data may also be edited, in whole or in part, by persons assigned to this purpose or by the person storing the data so that it is not excessive for a given patient. Time codes may be used to periodically determine that data needs to be considered for editing. Two or more storage areas, temporary, semi-permanent, permanent, etc. may be utilized to prevent too much data from being maintained. To protect data, an independent, remote operator may have to ok editorial review of records, although the marking through an Internet site may allow for this to be done at a later time or it may be done through video conferencing through the method taught herein.

Once the patient arrives the data is available over the Internet on admission and is also simultaneously being sent for analysis where appropriate.

Therefore pictures or medical readings and analysis are available at the emergency room consistently from the first point in time when a properly equipped individual starts to relay the data.

In addition smart software may determine where the victim requires referral to an appropriate expert and an appropriate expert may be obtained. This expert's analysis and records may later be transferred to the appropriate insurance-approved doctor so that a particular PPO or HMO can take records from an original source and have those available at the end provider's location without mail copies or the like.

Also disclosed herein is a unique method for allowing for the transfer while maintaining the patient's confidentiality and obtaining the appropriate consents so that all of the consent and permission are handled electronically.

With a series of displays of varying complexity a complete detail record of the patient's care, at least to the extent that it is digital data is maintained.

Once the additional medical records are scanned in, a complete digital patient history is available for transfer to any doctor and to any location anywhere in the world.

In this way a referring physician would automatically have the complete medical record on this patient without having those transferred.

In many cases where multiple MRI's are taken, the third or fourth doctors in the series will be reading an MRI and will have no idea what the prior records indicated. Here not only would they know what the prior diagnosis' were but through the novel method of maintaining records taught herein they would be able to look at the digitally enhanced records as well as the interpretations related to those and could even have a conference call or correspondence with the other physician.

The process may be described as imaging, marking the image with the various tag lines (referred to as markers later in the specification), associating the image with a time line by way of a time line identifier, storing the information, updating the time line, maintaining a data base, protecting the information so that it may only be accessed when desirable, providing a method for access and a time line in order to provide notices of items and patient billing and additional steps would be manipulating the data to enhance, enlarge, shrink, mark, colorize or take other actions on the data. It might also be to display it with or without a video data conferencing system. The storage would preferably be in one of the universal formats for digital data Analyzing could include utilizing a novel Internet communications set up allowing multiple users the ability to access and colorize or otherwise manipulate data, alter black and white, highlighting portions of a video or utilizing intelligent technology to examine or alter digitized portions either utilizing the highlighted portion or otherwise. Different views or views at different times may be compared in order to maintain a better record or variation in order to determine what variations have occurred over time utilizing intelligent software area comparison technology.

It is therefore an object of this invention to provide a method for storing and viewing medical records. It is a further object of this invention to provide a method for conferencing. It is a further object of this invention to provide an enhanced method for handling medical data and for sharing medical data.

These and other objects and advantages of the invention will become better understood hereinafter from a consideration of the specification with reference to the accompanying drawings forming part thereof, and in which like numerals correspond to parts throughout the several views of the invention.

### BRIEF DESCRIPTION OF DRAWINGS

For a further understanding of the nature and objects of the present invention, reference should be made to the following detailed description taken in conjunction with the accompanying drawings in which like parts are given like reference numerals and wherein:

FIG. 1 shows a data selection screen.

FIG. 2 shows a broad outline of the method including the steps of:

(1) imaging data;

(2) marking the data

(3) accessing data

(4) enhancing the data (e.g., 3-D modeling, alarm application, artificial intelligence) improving analysis by associating the analysis with a proposed diagnostic solution and comparison with similar data in other areas;

(5) analyzing the data by technician or with Image recognition software;

(6) manipulating the data;

(7) storage;

(8) sharing the data.

FIG. 3 shows a viewer screen with data selected from the screen described in FIG. 1.

FIG. 4 shows a less manipulated display where the user from FIG. 3 is sending data to the users with FIG. 4.

FIG. 5 shows a knowledge video network utilizing the technology disclosed herein.

FIG. 6 shows an alternate embodiment of the network from FIG. 5.

FIG. 7 shows a system overview of a network image storage area to be used in conjunction with the process set out in FIG. 1.

FIG. 8 shows an outline of how the Internet network would be designed.

FIG. 9 shows a block diagram of a web page incorporating the technology disclosed in the process steps of the preferred embodiment. A hypothetical case is used which shows the first screen that might be available from an emergency transport vehicle or from a home monitoring system.

FIG. 10 shows a system overview of the network architecture for the storage system shown in FIG. 12.

FIG. 11 shows the interaction between system users in block form.

### DETAILED DESCRIPTION OF THE PREFERRED EXEMPLARY EMBODIMENTS

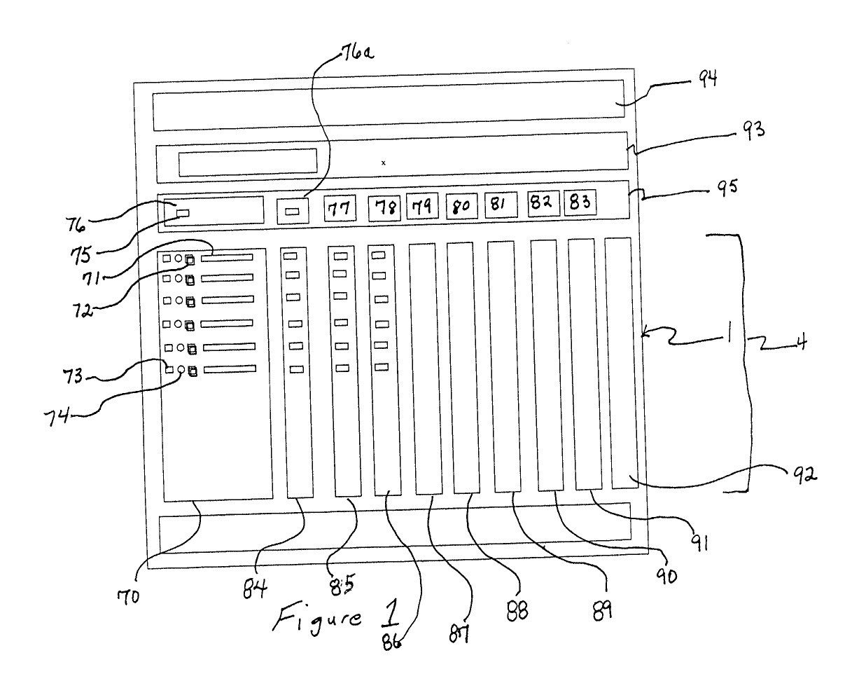

As can be seen by reference to FIG. 1, imaging occurs allowing one element of the patient's medical record 1 to be joined to other elements to form a group of elements. Elements represented by columns 4 are attached or otherwise electronically associated with images which are created digitally. This association may be done internally through hyperlinks which continue to function after the information has left the initial location (an intra-net) and moved on to the Internet location described in more detail below so that these specific documents can be accessed. In certain circumstance not every computer might be able to display the particular digital image which is recorded and in such a situation the link could be designed in order to identify the medical equipment which the user would need in order to download that.

Referring to FIG. 1, it can be seen that the first screen of the user may see includes file menus 94 over a hyperlink area 93 where the user may type in or select from a group of hyperlinks to navigate the site or other part of the Internet or Intranet.

There are then columns 4 and above at least on of the columns is a column search window 76. A name search term 75 can be entered into the main search window 76 in order to pull up a series of potential selection within the main column 70.

Looking at main column 70, it can be seen that it consists of a series, in this case 6, of main terms 71 along with attached report 72 and information 74 on the image which is connected to the main search term 71 by way of the main search term 71 being a hyperlink. There is also a selection box 73 which may be checked in order to display the main search term to the right of the selection box 73.

In addition to the main term in column 70 there is a patient name column 84, a date column 85, a coding column 86, a modality (type of equipment) 87, a body or equipment part 88, a main technician or physician 89, a reading technician or physician column 90, and there is an extra column here 91 which can be used for any of the purpose set forth here or above.

A search may be made relative to any secondary search term as shown in columns 84 through 92. In this case there is no search menu above column 92 because in this example, column 92 is not searchable by the user for reasons of security or other reasons internal to the system.

In search of main search term window 76 a secondary search term window 76a and then a third, fourth, fifth, sixth, seventh, eighth and ninth search term windows 77-83 respectfully so that the menu may be sorted by virtue of the search terms windows 95. This search may or may not be for terms only displayed in the main search term window 76. In the preferred embodiment any term entered into any of the search window 95 may be used in order to bring up the desired information so that different types of modalities showing specific body parts might be used in a teaching situation or otherwise.

There may be, as one of the markers, a safety key which would encode data so that it would not be misused or accessed without proper authorization.

One of the benefits of the digital data storage disclosed herein is that more portable storage medium currently in existence can be used in order to transfer parts of a patient's record or in fact the entire digital patient record so that a patient may obtain part of a digitized record and carry that with him to other providers to be utilized in connection with at home equipment thereby bypassing the need for the Internet or for hard copies or for other mechanisms for downloading the technology.

This might be important where a baseline was required in order to monitor medical information and the baseline could be maintained on the document and could then be uploaded to equipment. Examples where this might be appropriate would be, for example a diabetic or a heart patient. In the case of a diabetic knowing a normal range of health would be significant, in the case of a heart patient knowing the variation within a heart rate would be important to the extent that the equipment did comparative testing MP3 data could be utilized. Likewise an individual going on a trip would be able to carry important medical history.

It is therefore one method of utilizing the invention to take an x-ray image or comparable records and digitize it, set up a form of communication which allows it to be viewed and/or edited, and have the results be stored under a data base manager such as PAC system, in such a way that it is archived along the tag information type of elements (such the patient's name, the body part which was x-rayed, date, the location of hospital where the work was done, the treating physician, the location where it should be stored, etcetera) and then sending out the archive or a portion thereof to locations upon demand.

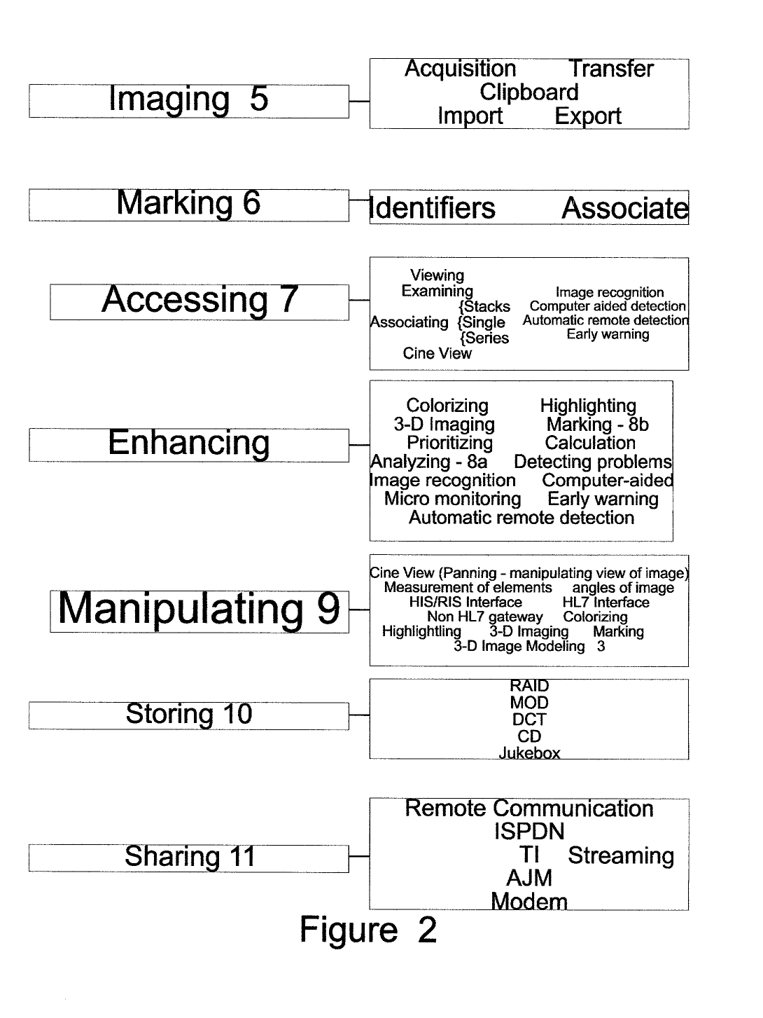

The process steps, as shown in FIG. 2, may be listed as: imaging, marking the image with the various tag elements, associating the image with a time line by way of a time element line element, storing the information, updating the time line, maintaining a database, protecting the information so that is may only be accessed when desirable, providing a method for access and a time line in order to provide notices of items and patient billing and additional steps would be manipulating the data to enhance, enlarge, shrink, mark, colorize or take other actions on the data.

FIG. 2 shows an broad outline of the method. As can be seen by reference to FIG. 2, the method comprises the steps of:

(1) Imaging data. Imaging data includes the acquisition of images and print media through scanning or digitizing equipment including x-ray, mri and the like. It also includes manually inputting data where appropriate and the import of data from other sources.

(2) Marking the data includes associating the images with information which adds value to the image in the manner described in reference to FIG. 1. It includes associating the image with patient or job information, dates, modalities, body or item examined, main physician or technician, reading (interpreting physician or technician), and other important information. Preferably these items are sortable as set out in reference to FIG. 1.

(3) Accessing the data is a broad step which includes viewing the data for several purposes. It includes viewing the data, examining the data, interpreting the data and displaying the data for use, and enhancing the value of the data. It can have under it the following process steps:

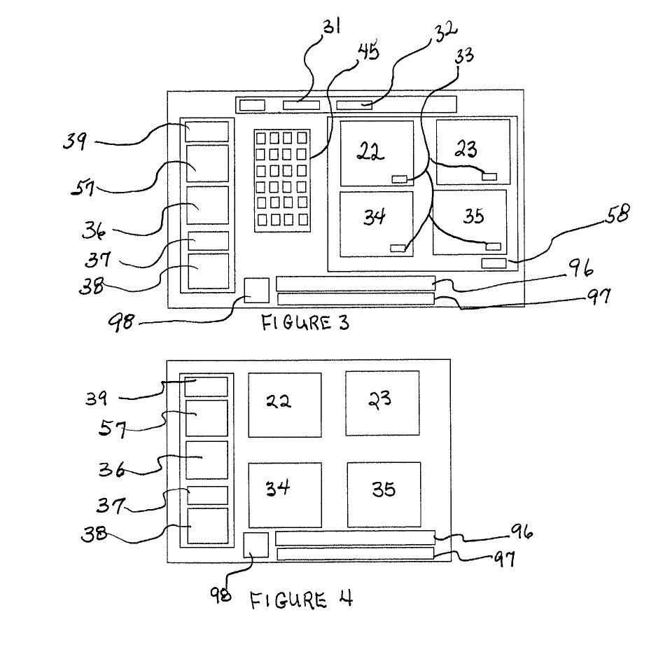

(4) Enhancing the data image. The value of the data has already been improved by marking the data or associating the data with pertinent information. The data is further enhanced by (a) analyzing the data and (b) attaching diagnosis to the data with hyperlinks 72, 74. Images can be enhanced by associating one image to another according to their relevance in a hierarchy for data streaming or display. 3-D modeling, alarm application, and the use of artificial intelligence can be used to improve the value of the data. Enhancing the data is also possible by associating the data with a proposed diagnostic solution and comparison with similar data in other areas. This enhanced product can then be shared with another for later enhancement or commentary. The data may be enhanced by associating images to produce video or presentations or collections of data as are shown in FIGS. 3 and 4 discussed in more detail below. The data may be improved by detecting problems in images, image recognition (by technician or computer aided), or adding time warnings or calendaring the images for later viewing, follow up treatment, or archiving to different layers of storage as discussed below. Analyzing 8 includes automatic or user measuring, colorizing, black and white, photos or highlighting portion of a video or utilizing intelligent technology the digitized portions either utilizing the highlighted portion or otherwise may be compared in order to maintain a better record or variation in order to determine what variations have occurred over time utilizing intelligent software area comparison technology.

(5) manipulating the data for particular uses is similar in scope to analyzing the data but is more directed towards changing the data, temporarily, permanently or by adding layers. This can be done by highlighting areas of interest, preferably in layers which are time stamped electronically so that the layers can be removed. The data is maintained, therefore, in it's original and modified form. To keep the data whole and to keep users working with the same product, the enhancement is preferably done at a central location. The data may be improved by colorizing the image or portions (highlighting). Panning or manipulating the view of the image improves its value. Measurement of elements or angles can improve it's value also.

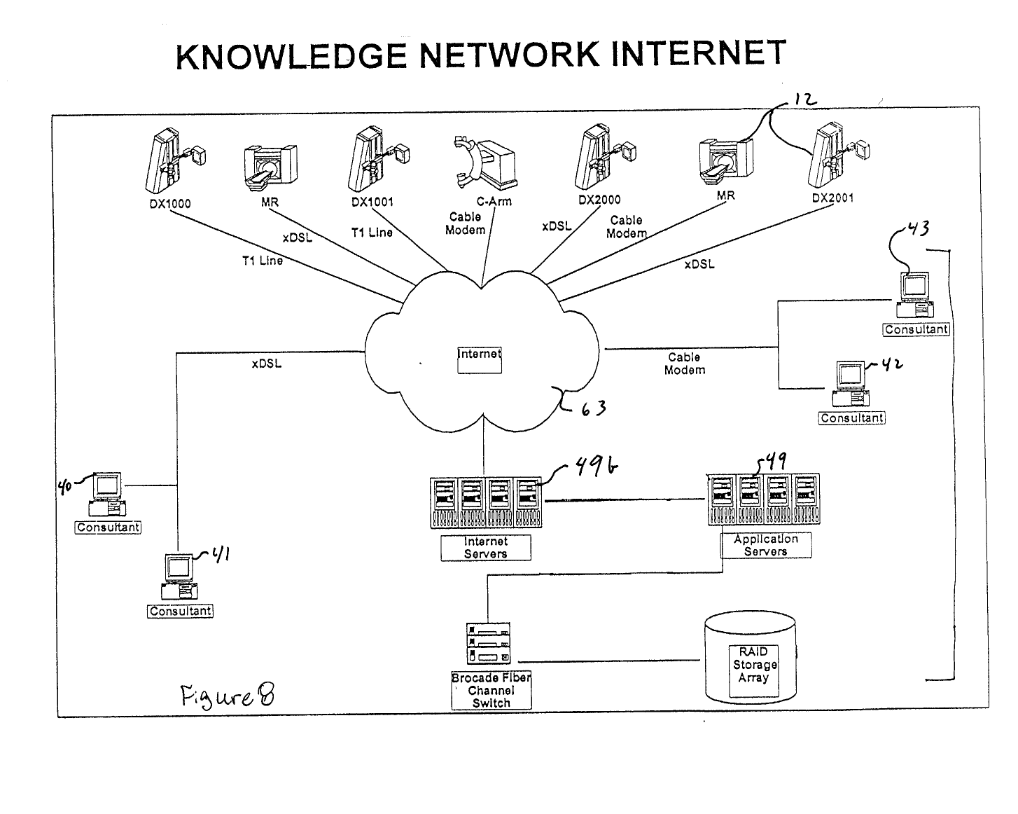

(7) The next step in the process which occurs at several levels involves storing the images and other data. This is done at several levels which can best be understood by reference to FIG. 7. Here there is a transitional storage of data at different levels according to the cost.

(8) Sharing the data is another process step. In sharing the data, it is not enough to allow other users to obtain the data. The sharing does occur on this level. However, the present embodiment envisions that individuals would work together to view and edit in real time as well as by storing video and text messaging while layers of comment, drawing, measuring or highlighting are added to the raw image or data. This allow the raw image to be sent to a location with a time marker. The image is then obtainable by a technician who can interpret the data or be assigned the data and then provide an interpretation. The interpretation, if not in real time is stored for use by the original user who sent the data for analysis in the beginning. Since the data is maintained at a central location, the raw data remains inviolate and obtainable by anyone with permission with only copies being made available according to the needs of the situation. The sharing is done utilizing the streaming method described below. The storage would preferably be in one of the universal formats for digital data such as DICOM 3.0 and markers associated with this format are provided for in the marking of the data described in reference to FIG. 1.

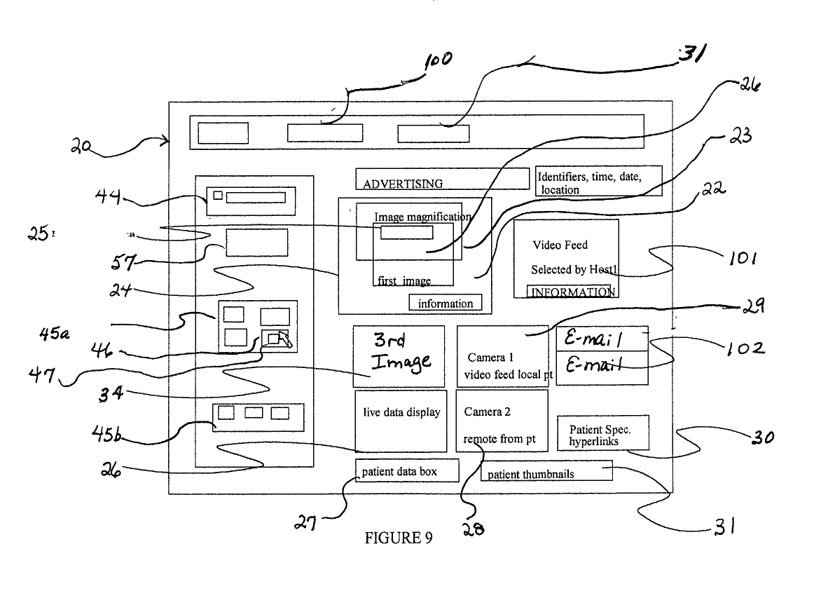

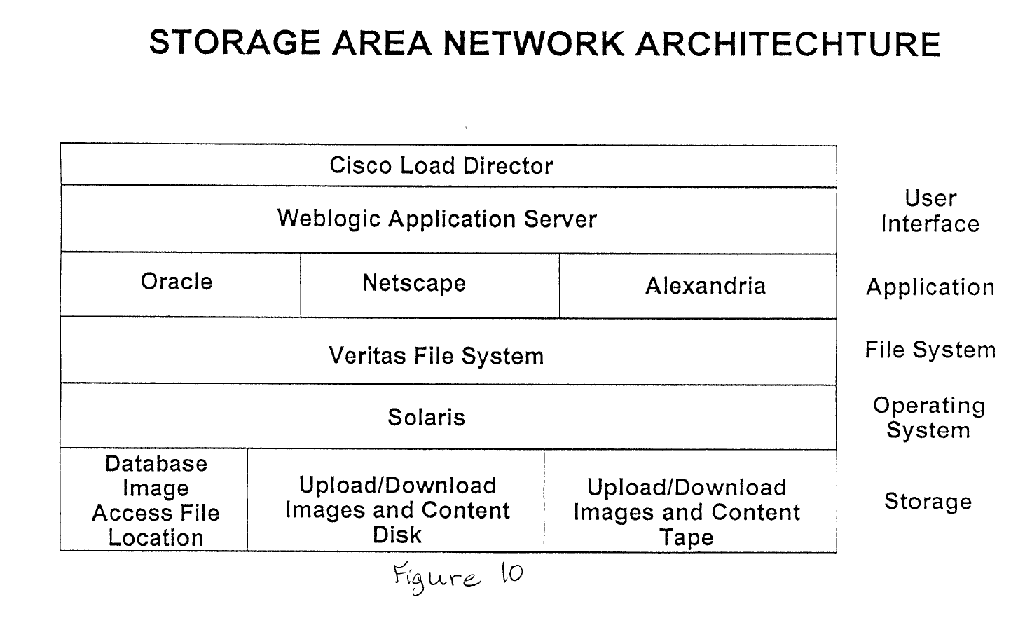

It is possible to share or display data with or without a video data conferencing system. Also live feeds from equipment are envisioned as described in FIG. 9 below.

FIG. 2 shows the elements of this invention, imaging 5, marking, accessing, analyzing and at some point by storing 10 and sharing 11 data. Manipulating data 9 may be shown before or after analyzing 7 since the system as described is an interactive process. The actual order of manipulation of the data, however, is more fluid and depends on the particular application in question and to a large extent, the technology envisions allowing for this more fluid handling of technical images.

Some of the benefits include the elimination of storage space and distance by having temporary type storage mechanisms on location but otherwise having the data stored centrally. The speed is increased since multiple users may access the same information simultaneously or may add to the information simultaneously since it is centrally accessed. Content handling includes the ability to split content into its various discrete units and access it by way of hyperlinks within an Internet or Intranet style data base.

Having the image digitized allows for increased reliability, easier storage, making the information available from a single Intranet of Internet network for access by other individuals within the system having access to codes for a particular data source.

As can best be seen by reference to FIG. 3 once information has been generally selected utilizing FIG. 1 the data begins to stream into the remote user's system (40-43a, for example, as shown in FIG. 7) in accordance with having a prioritization of the data based on prior use or based on the information selected. The user is sent codes for specific items and the computer is now sending related thumbnails sketches or thumbnail sketches ordered according to the needs of the user and these thumbnails sketches are displayed as they are received as thumbnail 45 shown in FIG. 3. The screen shown in FIG. 3 allows for the user to split the screen utilizing screen split control 31 and screen size control 101 allows for the size of the screen and the number of images shown on the screen to be controlled within the limits of the screen size.

To the left of the screen are switching controls 39, marking tools 57 for modifying the images or drawing on the images, file tools 36 for carrying out functions such as printing or saving changes or adding documents to the files, measuring tools 37 for measuring distances and angles of elements, automatic diagnostic tools 38 for allowing artificial intelligence within the system to locate information from the images.

In order to allow for better consulting there is a writing tool 98 which allow the user to not only write documents but to invite users whose addresses are shown in the address sent from screen 96 or the sent to addresses 97 which are typically Internet type addresses.

In the example shown in FIGS. 3 and 4 there are four images which have been elected to be displayed which are shown here as First Image 22, Second Image 23, Third Image 34, and Fourth Image 35. Consistent with the disclosure for FIG. 9 any of these images may be live video feeds or recorded video feeds as well as still x-ray type images.

With each image there is an image size control 33 which may also serve to identify the image. There is also an image selection identifier and size control 58 for all of the images together.

FIG. 4 shows where a secondary user contacted by the primary user controlling the screen shown in FIG. 3 was sent information which he can modify by sending information which is recorded at the central database and which changes show up on the primary user's screen shown in FIG. 3. Since less information may be necessary, the speed of access to the data may be improved by limiting the amount of information streamed to this secondary user's screen, even if he is simultaneously in contact with the primary user who's screen is shown in FIG. 3 in this example.

In this case the information sent to the secondary user shown in FIG. 4 is more limited. Rather than getting all of the thumbnails, he is just getting certain selected information which the primary user using FIG. 3 has sent to him.

Since he also has other tools he may or may not be allowed according the desires of the system administrator to go into the main system and draw up other units.

In this way only billing information or medical information or only images or certain video feeds but not all of the video feed might be sent to the user with screen 4. The communication, whether direct in time or utilizing the storage time delay in the communication, may be limited accordingly to enhance the speed of sharing data or to limit access based on the user's presumed need to know.

Digitization makes common pools of data, interpretations and commentary available over a wider audience area. The system includes coding the data so that various portions would be available to different users depending on their level of involvement and access and the privacy desired. Therefore the name and related information might not be available to someone who is compiling the data or accessing the data for interpretation purposes or for teaching purposes or in order to obtain commentary related to the data whereas other users might have access only to the name records and the type of data for billing purposes. Other users have a full access to the entire record.

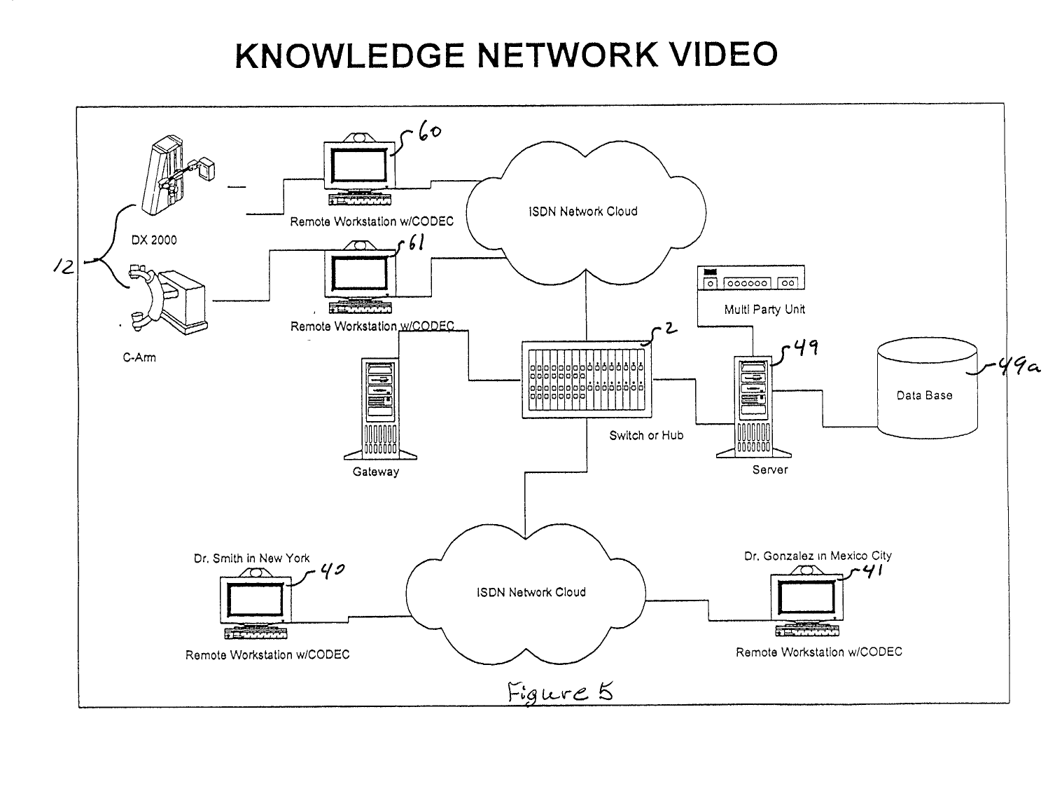

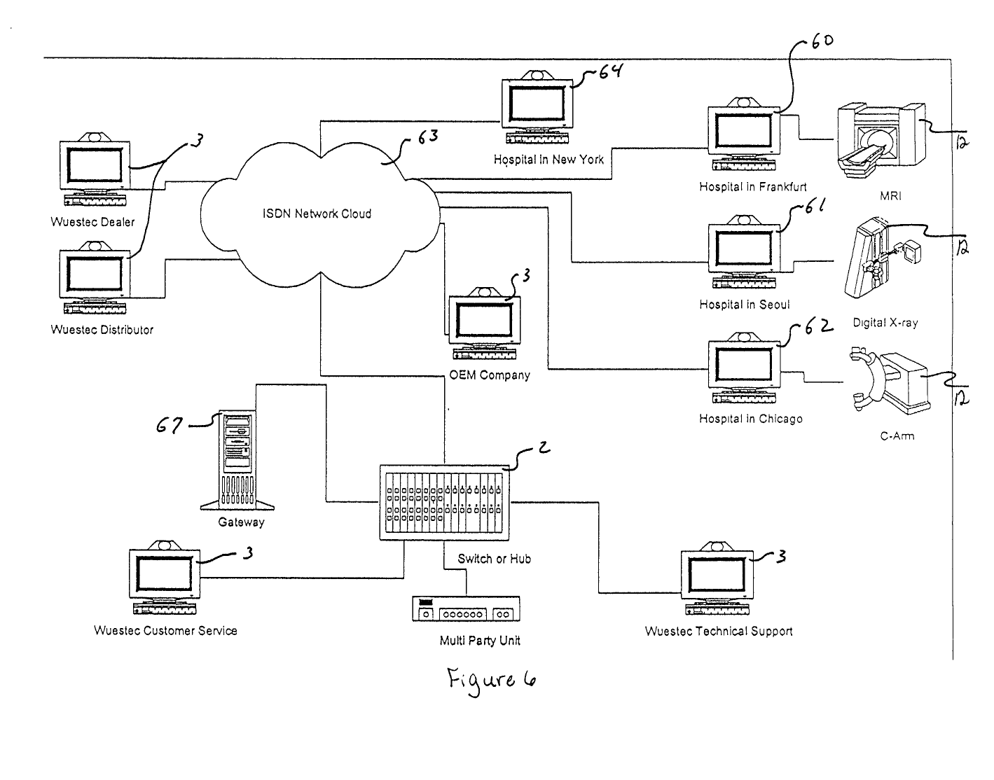

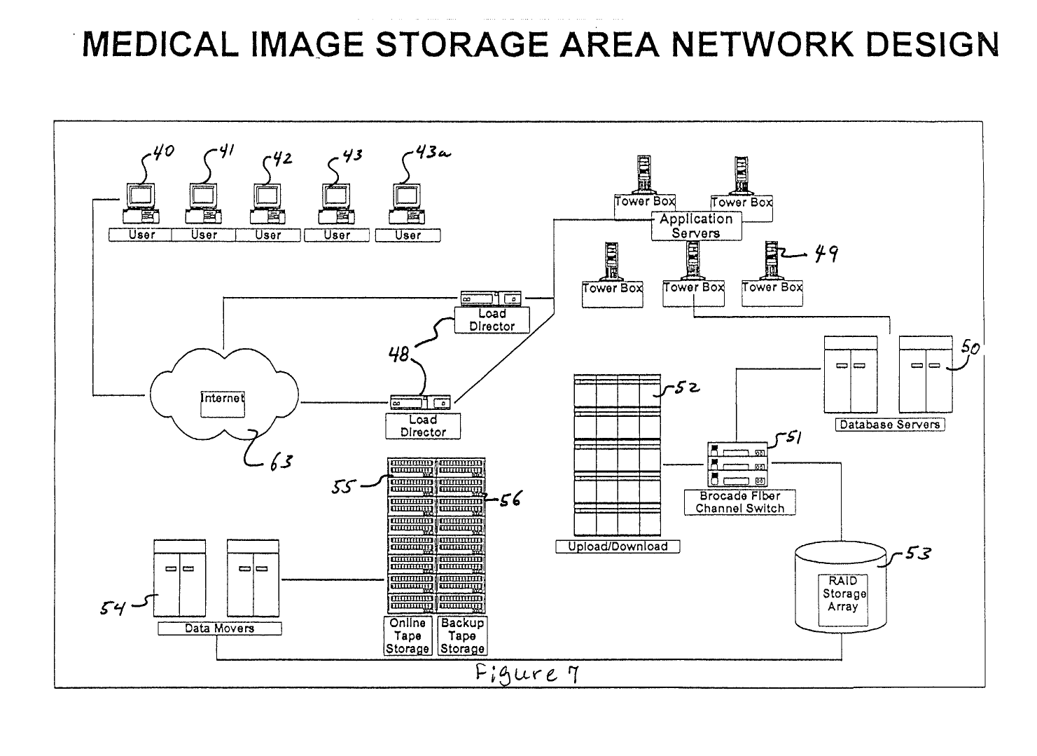

In order to utilize this technology common features are shown in FIGS. 6, 7, and 8. The elements of hardware necessary as well as software would include having a high definition imaging system 12, having a centralized storage system 13. Portable image storage systems 14 may be used. Portable storage unit databases may be reused since there is always knowledge that the originals will be maintained in a centralized data base. Internet retrieval system 15 a web based high definition digital data and video communication system, serves to accept information or having a non-web based high definition digital data and video communication Intranet storage system 16 having digital imaging, (e.g. digitized x-ray), equipment for accepting standardized billing records; artificial intelligent software for performing comparisons and enhancement of certain digital records as well as maintaining time keeping records; maintaining a data base of information and commentary for utilization by people examining records in the form of a encyclopedia; setting up a network of individuals having particular expertise for particular medical records accessible via the Internet and providing a method for allowing communication between these individuals and the medical service providers at regional locations. A system is included to take processed data and move it to a RAID storage after processing.

The use of the system can be better understand by reference to FIGS. 5, 6, 7, and 8 all of which show methods for practicing the invention either over and Internet or Intranet cloud, network 63. This Internet cloud or Intranet cloud, identified either as an ISB network or an Internet network is generally designated as network 63. Both the ISB network clouds and the Internet clouds function in the same fashion. The form of the network is not significant in supports the network when limited data accessibility due to the size of the ban width available over the network 63.

Not all the FIGS. 5-8 show all of the elements because they are not all functioning to accomplish all of the purposes of the invention. Where the images have been previously stored, for example, it is not necessary to do additional imaging studies.

FIG. 5 shows the simplest version of networking including two different high definition imagining systems 12 which connected to remote work stations 60 and 61. Each of these stations and 61 is equipped with streaming software which determines the most important item to send to the network and also coding information which directs the data to the appropriate source. Upon arriving at a switch 2 the equipment goes to an application server 49 and then to a database 49a which is a part of the server 49. The information is later accessible through the same switch 2. The examining doctor, in this example, is at work stations 40 and 41. These doctors would access information stored on the server for the particular purpose of allowing them access to that data for examination.

In FIG. 6 the same general process is used with out storage at the communication level with all of the data being utilized live from the originating location 60-62 for the data being utilized. Hospital station 64 is provided for cooperating as well as various support stations 3 which can be utilized to provide equipment or support or troubleshooting in the event of a need for that type of information utilizing the conferencing features of the equipment. The equipment my be designed to automatically direct the troubleshooter to a marker designating the location of a problem identifiable automatically by the equipment.

FIG. 7 replaces the Intranet network with an Internet network.

In this case the data is been previously loaded through the application servers on the application server database 49a (not shown) to database server 50 from which the data has gone, according to instructions in the software or from users, by way of a switch 51 to upload and download storage 52 or RAID storage 53 and then to data movers 54 which store the data in online tape storage 55 and finally in back up tape storage 56.

The purpose of this storage array is in order to have the highest cost storage in the tower box 49 to be moved sequentially to less and less expensive storage displays and finally to storage in the back up tape storage 56 which may be a read only storage mechanism.

In FIG. 8 the main difference is that Internet service 49b is separated from the application service 49 prior to the data being moved into storage. It can been seen here that the users 40-43 are dispersed in location and in fact actually access the data potentially through different band width mechanisms.

As shown in FIG. 7, load directors 48 are utilized in order to screen the data by utilizing prioritization so that larger images are sent in parts or portions depending on their importance so that the system gives the information immediately necessary and this builds up the image so that data is constantly streamed with the most important data first. In this way the user might start with the particular section of the body and the surrounding sections displayed in the image would be added as time and band width allowed according to the directions of a load director 48. These directions could be determined using artificial intelligence based on the habits of the user or based on the needs for information determined by the artificial intelligence screening which might in turn be specified by the user.

Face to face communications are provided via split screens as shown in FIGS. 3 and 4. FIGS. 5-8 show how these communications might occur with both individuals having before them the same data has also been developed as a part of this system a different computer CPUs 40-43.

Some of the advantages of the system are to provide low storage costs, low labor costs by centralizing the supply experts, low consumable costs, eliminating the non-digital consumables of x-ray. Operating costs are reduced as a result of the afore mentioned reductions; having a knowledge source for obtaining information either by contract or per item pricing; having a core of initial crew services including having the ability to trouble shoot systems via the conference calling capabilities of the system; providing on sight training utilizing the face to face web system described herein; having quick responses to services as a result of not requiring multiple visits; having competitive pricing as a result of the other savings; having a low investment as a result of eliminating in house radiologists as well as initial consumable purchases; providing a method for billing on a per service basis and providing direct billing through the automated system including billing for insurance; eliminating the need for new infrastructure by allowing existing infrastructure to carry much of the telecommunications burden and utilizing hand terminals to transfer data for particular patients where carrying data is necessary; providing ultra high resolution; having flexibility for purposes of billing and obtaining experts and utilization of particular diagnostic tests and storage mechanisms; and increasing productivity and reliability through central or centralized technology storage and remote storage access.

The medical imaging technology (high definition systems 12) may include x-ray technology, ultra sound technology, MRI technology, CT Scan technology, Gamma Scan technology, PET technology. These different modalities can all be utilized using the present system and the present system also allows for comparison of similar data of identical area exposures in the various systems both through the use of intelligent technology and through the multi screen capabilities envisioned herewith along with the abilities to over lay on project those.

As shown in the examples, this process enhances the ability to do tele-medicine or remote medicine.

Various levels of detail might be utilized by different users and software would be designed in order to allow a user to utilize band-width according to their particular needs. For example a technician merely looking at the data may want to enhance the visibility of a on site down load of a particular x-ray image whereas an on location medical records technician would have very little interest in having a detailed view but instead a summary review of any images (such as thumbnails) would be adequate. Detailed records concerning the patient and data and his course of treatment could be included by digital markings on these thumbnails.

Another way of describing the mobilization of data feature would be to provide a local area network of digitizing medical equipment and access equipment connected to a global access system such as an Internet system 15 which is connected to other local area networks which would utilize the technology from the first local area network in order to do analysis or billing or other activities.

The network system would be comprised of a digital imaging community in the fields of x-ray, CAT scan, etcetera; having analysis and practice for groups those systems; having a billing network foundation; having an ordering system for buying and leasing equipment as well as ordering information related to a particular patient; allowing a bed and contract submission market place for buying and selling information; providing a location for auctions and sale of equipment and contract labor; and providing face to face discussion groups along with the face to face network which allows for direct and immediate face to face contact for technical service, patient service and customer service this will lower the costs to serve particular patients, equipment and locations; build relationships, increase customer contact and provide better marketing feedback and understanding.

FIG. 9 shows a block diagram of a web page incorporating the technology disclosed in the process steps of the preferred embodiment. A hypothetical case is used which shows the first screen that might be available from an emergency transport vehicle or from a home monitoring system. FIG. 9 shows how a screen 20 would show the linked data in order to show system links 21 for information available for everyone. A manipulation screen 24 is provided within the Internet system which allows either of two users to manipulate the information displayed within the manipulation screen 24. In this case the manipulation screen only has two images to move. The first is a first image 22 and the second is a second image 23. A third layer of manipulation is a highlighted area 25 which is adding a highlighting, text or other data to a common area where two images are overlaid 36.

One improvement incorporated into the art by this invention lies in having a remote image editing arrangement using data streaming. Specifically, using the example shown in FIG. 9, the following occurs:

1) The user calls up, using name or coding menu 44, a specific client.

2) From a group of thumbnail sketches 45 (other forms of designation, such as coded numbers or descriptive terms may be used), the user selects a specific thumbnail 46. Graphically, the user may select a portion 47 of this thumbnail 46.

3) The streamer takes coding information provided from the user's selection and begins streaming data most relevant to the portion 47 in question to the user in order to minimize uploading.

4) As the system finishes, smart technology begins to furnish the balance of the record based on selections made by the user. This could include additional patient information, the balance of a drawing represented by the specific thumbnail 46 not selected, the balance of a larger selected area, or additional drawings from the thumbnails 46.

5) At the users' location, the information is displayed, but not permanently recorded unless the requirements of the system are altered by overriding the default.

6) As the user makes changes by marking drawings or doing overlays, measuring, adding identifying cross references or the like, the changes are saved on a layer identifying the user which layers may later be removed or edited by the user or other user with the user's permission. However, these changes remain stored only at the remote location.

7) If the user elects to prepare specific documents associated with the record, these are also stored remotely although they may be accessed at any time by participants having appropriate authority to do so and to a limited extent printed for in office records.

8) The user may elect to order portions to be permanently kept by the user which are then time stamped and a record kept of the version submitted for permanent storage at a remote location controlled by the user.

9) If a second user is conferencing on the case, then both are sending changes to be stored at the remote location. Both can do this simultaneously, seeing the changes that each other makes as the drawings are changed at the remote central storage area 19. The changes are typically not permanently made as they are edited in such a discussion group until one member or the other elects to make them permanent.

10) In order to maximize time usage, notes and video may be stored for later access by other users who may then add comments or drawings (markings on the image) which are then stored for remarks, if any by revisits from the initial user or subsequent other users.

11) In order to maximize cost savings of storage, as shown in FIG. 12, there are different levels of storage which determine the amount of data which is kept available at different speeds for the system.

12) At the first level the user at a cpu 40-43a signs onto the internet and joins the system. Based on information provided by the user utilizing the steps above a load director 48 sends to the application servers requests for specific information and uses intelligent software to begin to locate more remote but related information which might be desired and to move it to a higher access location. In this case, the access locations are shown in order of cost although their contact between each other is controlled by the load director directing information according to the most time and cost effective method.

13) In this case the data is stored at the servers temporarily for editing and later transfer to another storage unit.

14) A database server 50 is where ready access to large portions of data are maintained.

15) A brocade fiber channel switch controlled by the application servers or related CPUS determines where the data should go from there.

16) The upload or download unit 2 may hold some data which comes, sequentially from storage at the RAID storage array 53, the data is stored then at data movers 54 which in turn go to more permanent and slower online tape storage 55 which is periodically backed up at a backup tape storage 56 which may be a read only storage location.

17) In order to expedite this procedure the data is maintained in a veritas file system shown in FIG. 13 which allows for pointers to data to be kept in flat file manager while that large bulk of the primary data is kept in a less expensive storage location.

A more traditional remote live data display 26 is shown which may contain patient data or a more traditional manipulation area such as a chat area. A patient data box 27 may have billing and other information related to the patient and other marker type information. It may also contain a password needed for users to log onto the data represented on each line to the patient data box 27. The password may allo for users to log onto the data represented on certain lines only depending on the needs of the user.

Two video feeds are shown here although the number of video feeds may vary. Here a remote video feed 28 showing the remote user and a local video fee 29, here a display of the patient as an example, are shown; the number and type of displays may vary according to the needs of the industrial or medical use. Patient specific hyperlinks 30 are provided to obtain other information related to the patient and some images or data may be accessed through hyperlinks incorporated into thumbnail pictures 31 displayed on the page. Two users may have the same or different video feeds. In one example the feeds would be identical for selected items (selected by one of the users) except that video feeds would differ.

A forced feed 101 may provided by the system giving information required by the provider of the software and hardware. E-Mail or instant messaging feeds 102 are also provided.

This process may be used for medical purposed or for other personal or industrial purposed substituting a mechanical image for a patient image.

The method of displaying information on a remote computer accessed database and network for at least one local user and one remote user may be comprised of the steps of:

a) providing a first web site screen divided into discrete areas according to the needs of the user;

b) displaying the linked data in order to show system links 21 for information available for everyone accessing the remote database and network;

c) providing a manipulation screen 24 which displaying information and allows at least one or at least two users to manipulate the information displayed within the manipulation screen 24;

d) providing multiple manipulation images which can be displayed on screen;

e) allowing a third layer of manipulation in a highlighted area 25 by adding highlighting, text or other data to the area where at least on of the images are displayed;

f) providing a more traditional remote live data display 26 is shown which may contain patient data;

g) storing for later review or comment data or video or images;

h) providing a typed interface or chat area;

I) providing a patient data box 27 with or without billing and other information related to the patient and other information;

j) providing at least one access limiting feature to portions of the data or all of the data;

k) providing at least on video feed showing information relative to a teleconference;

l) providing at a separate area at least one different video feed in the space other wise provided for at least one video feed;

m) providing patient specific hyperlinks 30 to obtain other information related to the patient;

n) providing access to images or data through hyperlinks incorporated into thumbnail pictures 31 displayed on the page.

FIG. 6 shows a face to face private network wherein the equipment is utilized in order to provide for support. As can be seen in FIG. 6 there is imaging equipment here shown as an MRI digital x-ray and C-arm each of which are connected to a hospital CPU 60-62 which in turn are contacted to the ISDN network cloud 63 which is the hub network for entire Intranet system. This allows an analysis hospital 64 having a OEM company 65, a dealer 66 and a distributor 67 to provide customer service and technical support. This network is tied in with a stand alone storage and image manipulation unit (billing, storage, comparisons, access control, etcetera).

The storage network could be an Internet based storage area network. Such as is shown in FIG. 12. a secured image storage and retrieval service, a direct connect installed base, virtual map disc storage, modality dependent and independent storage areas and correction OICH image knowledge; image processing and manipulation, user demand functions, billing software for access to the system, for storage in the system and for billing particular medical treatments, would allow for reduced costs limited by having remote storage and economies of scale.

This would also provide the advantage of establishing customer based profitable levels.

Uploaded or down loaded storage could also have temporary storage areas in order to allow it to be put into the system at the point in time where it was to be accessed.

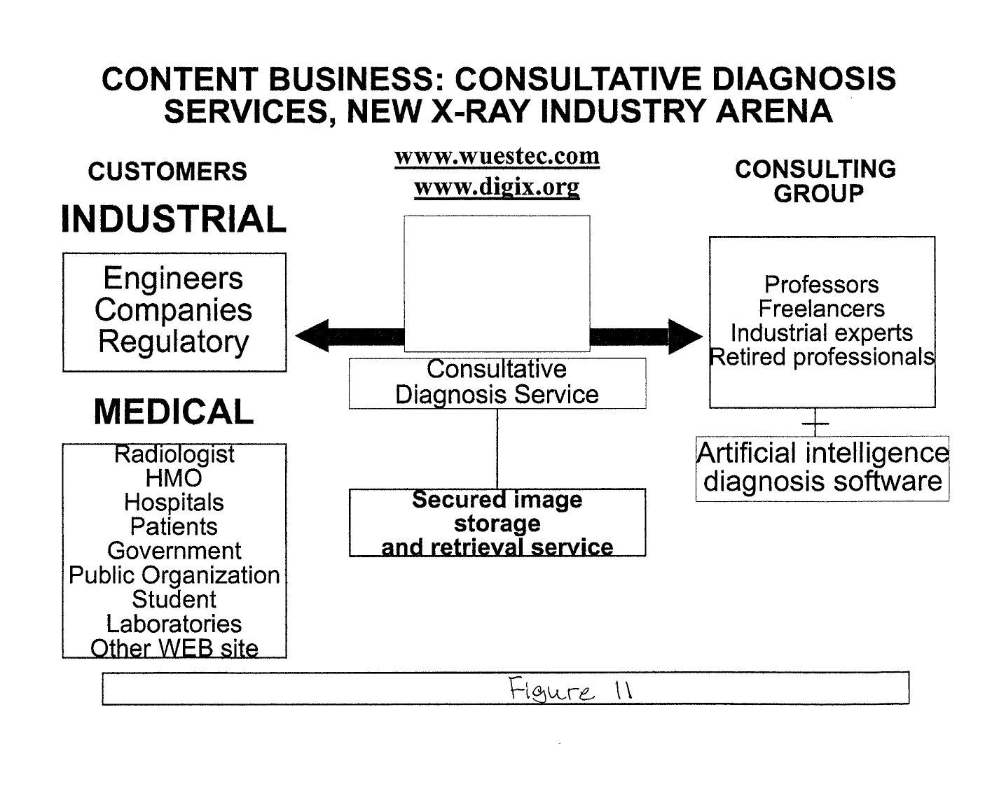

The storage area network architecture is set out in FIG. 10.

A second tier of intelligent software would be in order to detect and analysis problems and to remove uncertainty by specifying when and where new diagnostic images were required. It would also include automatic remote detection of problems and/or early warning of problems as well as monitoring of the equipment for maintenance and billing.

This would provide for independent remote diagnostic services as well as for tele-medicine and non-destructive testing applications in other industries utilizing existing x-ray equipment, and more particularly digitized x-ray equipment. It would serve to solve radiologists concentration in some areas and shortages in other areas by providing additional work to radiologists where they are over concentrated and providing a source of radiology readings where there are remote applications.

The customers of the system would include industrial customers such as engineers, companies requiring testing and regular core agencies; in the medical field radiogists, HMO's, hospitals, patients, government organizations, public organizations, students, laboratories and other web sites.

The consulting services and diagnostic services would be handled from a centralized area with secured image storage and retrieval services also being offered.

Resources would include consulting groups from professors, free lancers, industrial experts, retired professionals and artificial intelligence diagnostic software both within the system and accessed from other comparable systems.

This could be utilized in a industrial setting. By way of example, a pressure vessel is radiated and the data digitized. Defects may be highlighted on sight or under analyses later. The data is uploaded and analyzed using an onsight or remote software unit. Finally, the data is mobilized by storing the data where it may be examined remotely by a centralized examination unit. This same process for monitoring or locating cracks within an industrial unit, such as a nuclear power plant. In such an environment, the local unit doing the initial digitization may or may not be automated.

In a military setting this information could utilized in order to provide information available at various distances from a battle field type operation. It is to be noted that the same technology would be utilized in the same way for rural medical applications where similar requirements of immediate treatment and transportation are experienced. It is noted that the direction of information flows in both directions, to the head quarters for analysis and back to the field hospital, here through a wireless communications unit, for use.

The data is enhanced over traditional methods by the application of the process through the steps of Analyzing and Digitizing. The user may acquire the image digitally originally or it may be acquired on film with a subsequent digitization. The value of the data is relatively limited by access. Manipulating the data through data processes of the type set out above; storing the data so it is anywhere on a network; accessing the data or communicating the data via email or accessing a network and interpreting the data enhances its value. A user who has access to the data is able from a centralized location to interpret a wide amount of data, eliminating the problem inherent in under served communities.

Because many varying and different embodiments may be made within the scope of the inventive concept herein taught and because many modifications may be made in the embodiment(s) herein detailed in accordance with the descriptive requirements of the law, it is to be understood that the details herein are to be interpreted as illustrative and not in a limiting sense.

1. A method for using data comprising the steps of:
(a) imaging data;
(b) associating the data with at least one marker;
(c) storing the data to a remote centralized data base accessible through a network;
(d) organizing the data for access by a first user to a given format;
(e) accessing the data by a first user;
(f) adding data by a first user;
(g) accessing the data by a second user in the given format of the first user.

2. The method of claim 1 wherein the data comprises medical data.

3. The method of claim 1 wherein the accessing by the first user occurs at the same time as the accessing by the second user.

4. The method of claim 1 further comprising the step of adding data by the second user.

5. The method of claim 1 further comprising formatting the data by second user.

6. The method of claim 1 wherein the step of marking further comprises the step of setting organizational priorities from highest to lowest to the data and organizing the data into discrete portions according to the organizational priorities.

7. The method of claim 7 wherein the step of accessing the data further comprises the step of accessing the data beginning with the highest priority to the lowest priority.

8. The method of claim 1 wherein the step of adding data comprises analyzing the data and associating by electronic storage and pointer a written report with the data.

9. The invention of claim 1 wherein the step of adding data by a first user further comprises the step of analyzing the data.

10. The invention of claim 9 wherein the step analyzing the data further comprises the step of applying image recognition software to the data.

11. The invention of claim 9 wherein the data is a medical image and wherein the step analyzing the data further comprises the step of applying medical analysis.

12. The invention of claim 9 wherein the step analyzing the data further comprises the step of attaching a report reflecting the analysis to the data.

13. The invention of claim 1 wherein the data is in portions and wherein the step of adding data further comprises the step of enhancing the data for at least one purpose from the group of purposes comprised of:
(1) highlighting an area,
(2) enlarging an area,
(3) cropping an area,
(4) adding text to an area,
(5) associating the data with a related image,
(6) overlaying the data with a related image, and
(7) making comparisons with later digital data of the same area;
(8) measuring at least a portion of the data
(9) determining angles in at least a portion of the data
(10) coloring at least a portion of the data;
(11) combining the data with other data to create a stream of data.

15. The method of claim 1 wherein the setup of accessing the data further comprises the steps of:
(1) displaying the data to at least one first user;
(2) simultaneously displaying additional data from the group comprised of:
(a) a vocal chat area,
(b) a visual of the first user,
(c) a visual of the second user,
(d) related medical data.

16. The method of claim 15 wherein the related medical data is a live feed from input from a patent.

17. The method of claim 16 further comprising the step of displaying the at least one go marker and associating all or part of the exchange in digital form associated with the at least one market so that the portion of the exchange is available with the at least one marker.

18. The method of claim 1 wherein at least one of the markers is a time marker so that the data is time sequenced.

19. The method of displaying information on a remote computer accessed database and network for at least one local user and one remote user may be comprised of the steps of:
a) providing a first web site screen divided into discrete areas according to the needs of the user;
b) displaying the linked data in order to show system links 21 for information available for everyone accessing the remote database and network;
c) providing a manipulation screen 24 which displaying information and allows at least one or at least two users to manipulate the information displayed within the manipulation screen 24;
d) providing multiple manipulation images which can be displayed on screen;
e) allowing a third layer of manipulation in a highlighted area 25 by adding highlighting, text or other data to the area where at least on of the images are displayed;
f) providing a more traditional remote live data display 26 is shown which may contain patient data;
g) storing for later review or comment data or video or images;
h) providing a typed interface or chat area;
i) providing a patient data box 27 with or without billing and other information related to the patient and other information;
j) providing at least one access limiting feature to portions of the data or all of the data;
k) providing at least on video feed showing information relative to a teleconference;
l) providing at a separate area at least one different video feed in the space other wise provided for at least one video feed;
m) providing patient specific hyperlinks 30 to obtain other information related to the patient;
n) providing access to images or data through hyperlinks incorporated into thumbnail pictures 31 displayed on the page.

20. The method of claim 1 further comprising the step of identifying specific thumbnails for display and sharing only these thumbnails with a second user for simultaneous review.
